(19) United States
(12) Patent Application Publication
(10) Pub. No.: US 2022/0172618 A1
(43) Pub. Date: Jun. 2, 2022

(54) Electronic Control Device For A Vehicle And Method For Reducing Intersection False-Positive Detection

(71) Applicant: Continental Automotive Systems, Inc., Auburn Hills, MI (US)

(72) Inventors: Luis Javier Del Real Ibanez, Rochester, MI (US); Ulrich Stählin, Oakland Township, MI (US); Paul D Bingham, I, Canton, MI (US)

(73) Assignee: Continental Automotive Systems, Inc., Auburn Hills, MI (US)

(21) Appl. No.: 17/594,303

(22) PCT Filed: Apr. 8, 2020
(86) PCT No.: PCT/US2020/027256

§ 371 Date: Oct. 9, 2021

Related U.S. Application Data
(60) Provisional application No. 62/833,306, filed on Apr. 12, 2019.

(51) Int. Cl. G08G 1/0967; B60W 60/00

(52) U.S. Cl. CPC G08G 1/096783; G08G 1/096716; G08G 1/096725; H04W 4/44; B60W 60/001; B60W 2552/05; B60W 2556/45; G08G 1/09675

(57) ABSTRACT

A method and system supported by a vehicle for reducing false positive intersection detection is provided. The method includes receiving roadside information from a roadside unit positioned along a route of the vehicle. The method includes determining a type of road condition based on the received roadside information. The method also includes determining when to output a road status signal including the type of road condition to at least one of a vehicle user interface or an autonomous vehicle controller supported by the vehicle based on the determined type of road condition. The road status signal causing the user interface to display a message to the driver or causing the autonomous vehicle controller to adjust a vehicle behavior based on the type of road condition.

### CROSS-REFERENCE TO RELATED APPLICATIONS

The present application is a National Stage Application under 35 U.S.C. 371 of International Application No. PCT/US2020/027256 filed on Apr. 8, 2020, which claims the benefit of U.S. Provisional Application No. 62/833,306 filed on Apr. 12, 2019, in the U.S. Patent and Trademark Office, the disclosures of which are herein incorporated by reference in their entireties.

### BACKGROUND

### 1. Field

The disclosure relates to an electronic control device for a vehicle, a corresponding method for reducing intersection false-positive detection, a roadside unit and a corresponding system.

### 2. Description of Related Art

Intersection Movement Assist (IMA) Applications warn drivers of vehicles approaching an intersection when it is not safe to enter the intersection e.g. because of another vehicle crossing the intersection which may not be visible due to obstructions. In other words, IMA warns drivers when it is unsafe to enter an intersection due to high collision probability with other vehicles at the intersection. IMA supported by a first vehicle attempting to cross an intersection, relies on location information from a second vehicle to avoid danger, even if the view to the second vehicle is blocked. In some examples, the IMA supported by the first vehicle may interpret some road conditions, e.g. curved roads, as intersections resulting in an output of false-positive warnings.

### SUMMARY

One aspect of the disclosure provides an electronic control device supported by a vehicle and configured to reduce false positive intersection detection. The electronic control system includes data processing hardware, and memory hardware in communication with the data processing hardware. The memory hardware stores instructions that when executed on the data processing hardware cause the date processing hardware to perform a method including operations. The method includes receiving roadside information from a roadside unit and determining a type of road condition based on the received roadside information. The method also includes determining when to output a road status signal including the type of road condition to at least one of a vehicle user interface or an autonomous vehicle controller supported by the vehicle based on the determined type of road condition. The road status signal causes the user interface to display a message to the driver or causes the autonomous vehicle controller to adjust a vehicle behavior based on the type of road condition.

Implementations of this aspect of the disclosure may include one or more of the following optional features. In some implementations, method/operations further include receiving a vehicle-to-X message from another vehicle and determining an existence of an intersection along the vehicle route based on the vehicle-to-X message. In this case, when the type of road condition is an intersection, the method/operations include outputting the road status signal. When the type of road condition is not an intersection, the method/operations include not outputting the road status signal.

In some examples, the roadside information is received at a wireless communication device supported by the vehicle and in communication with the data processing hardware.

The method/operations may also include receiving a target vehicle position (e.g., from a position determination device supported by the vehicle) of a target vehicle and a target vehicle dynamics information (e.g., from a vehicle dynamics determination device supported by the vehicle) of the target vehicle. The method/operations may include determining a first predicted route based on a vehicle position and vehicle dynamics information of the vehicle and determining a second predicted route based on the received target vehicle position and the target vehicle dynamics information. The method includes determining a potential hazardous situation based on the first predicted route and the second predicted route and outputting the road status signal including signal data. The signal data includes the potential hazardous situation and the determined type of road condition.

In some implementations, when signal data of the road status signal indicates that the road condition is not an intersection, the data processing hardware does not output the road status signal. While when signal data of the road status signal indicates that the road condition is a curved roadway, the data processing hardware does not output the road status signal.

The roadside information includes at least one of Roadside Alert information or information describing a geometry of a roadway the vehicle is driving on. Additionally or alternatively the roadside information may include a MAP message or a SPaT message.

In some implementations, the data processing hardware provides at least part of the determined type of road condition to at least one of further driver assistance applications or autonomous driving applications. The driver assistance applications, may include, but are not limited to, Electronic Emergency Brake Light (EEBL), Forward Collision Warning (FCW), Stationary Vehicle Warning (SVW), and Control Loss Warning (CLW). The data processing hardware may output at least part of the determined type of road condition to a path prediction module of the vehicle.

Another aspect of the disclosure provides an electronic control system supported by a vehicle and configured to reduce false positive intersection detection. The electronic control system includes data processing hardware and memory hardware in communication with the data processing hardware. The memory hardware stores instructions that when executed on the data processing hardware cause the date processing hardware to perform operations. The operations include receiving a vehicle-to-X communication and determining a presence of an intersection along a road in front of the vehicle for examples based on the vehicle-to-X communication. The operations also include receiving data from one or more vehicle systems supported by the vehicle and confirming the presence of the intersection based on the data. When the presence of the intersection is confirmed, the operations further include sending a warning message to a vehicle user interface or an autonomous vehicle controller supported by the vehicle. The vehicle user interface displaying the warming message to a driver or the autonomous vehicle controller adjusting a vehicle behavior.

Implementations of this aspect of the disclosure may include one or more of the following optional features. In some implementations, the one or more vehicle systems includes a wireless communication device configured to receive roadside information from a roadside unit positioned along the road. The data includes the roadside information. In some examples, the one or more vehicle systems includes a position determination device configured to determine a vehicle position; the data includes the vehicle position. Additionally or alternatively, the one or more vehicle systems may include a vehicle dynamics device configured to determine vehicle dynamics data; the data includes the vehicle dynamics data. Additionally or alternatively, the one or more vehicle systems may include a path prediction module configured to determine a predicted vehicle path; the data includes the predicted vehicle path.

In some examples, when the presence of the intersection is not confirmed, the operations include not sending a warning message.

Another aspect of the disclosure provides a roadside unit that includes a data memory storing information and a processor reading the information indicating a type of road condition stored in the data memory. The roadside unit also includes a wireless communication device sending the information indicating the type of road condition.

Implementations of this aspect of the disclosure may include one or more of the following optional features. In some implementations, the Roadside unit is configured to at least one of broadcast the information or to transmit the information after reception of a vehicle-to-X message from a vehicle. The Roadside unit may be configured to transmit the information only to vehicles approaching into the direction of the Roadside unit. Additionally or alternatively, the Roadside unit may be configured to send at least one of Roadside Alert information (RSA) or information describing a geometry of a roadway.

The details of one or more implementations of the disclosure are set forth in the accompanying drawings and the description below. Other aspects, features, and advantages will be apparent from the description and drawings, and from the claims.

### BRIEF DESCRIPTION OF DRAWINGS

FIG. 1 is a schematic view of an exemplary vehicle that includes an electronic control device during a traffic situation;

FIG. 2 is a block diagram of the electronic control device of FIG. 1;

FIG. 3 is a block diagram of the Roadside Unit of FIG. 1; and

FIG. 4 is a flowchart of operations for reducing intersection false-positive detection based on the traffic situation shown in FIG. 1.

Like reference symbols in the various drawings indicate like elements.

### DETAILED DESCRIPTION

Many IMA implementations exist, which, in principle, are based on information provided by other vehicles by way of vehicle-to-X communication. Therefore, a vehicle supporting an electronic control device executing an IMA application may utilize information received from a Roadside Unit (RSU) to reduce the number of false-positive intersection detections determined by the IMA application. The vehicle supporting the electronic control device determines the type of the particular road condition based on the received RSU information. The RSU information may include details relating to the road such as a curved road or intersection, the further path of the roadway, or any related road. In some examples, the vehicle also includes a wireless communication device that receives RSU signals and transmits signals to the RSU or to other vehicles.

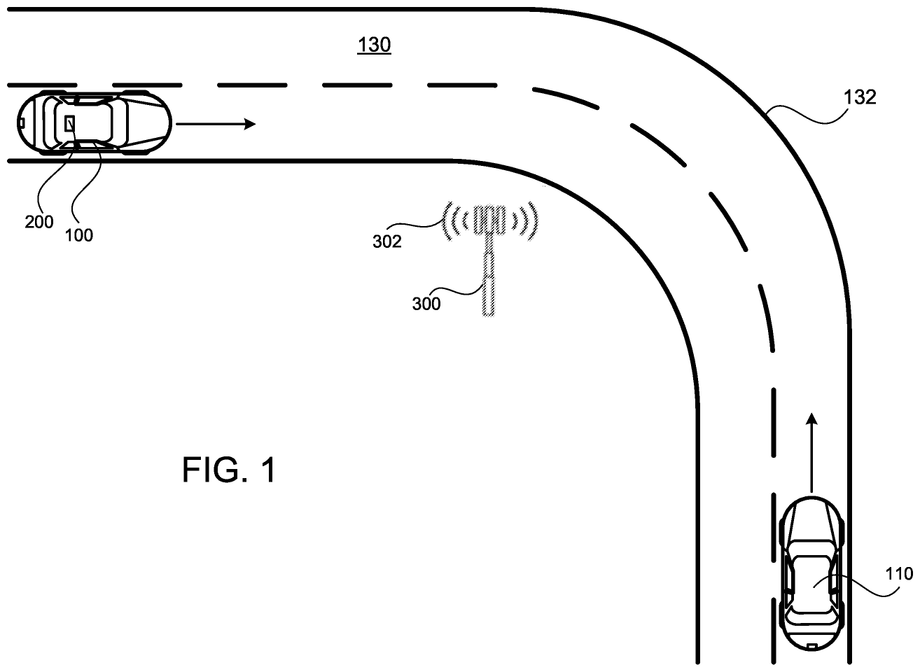

Referring to FIGS. 1-3, in some implementations, an Ego vehicle 100 (also referred to as a first vehicle 100) with an electronic control system 200 is approaching an intersection point in a curved roadway 132. The vehicle 100 may be a motor vehicle, such as, but not limited to, a passenger motor vehicle, a commercial motor vehicle, a motorcycle, an electric motor vehicle or a hybrid vehicle. A Target or second vehicle 110 having a Vehicle-to-X communication device is approaching from an opposite direction of the curved roadway 132. The vehicle corresponding arrows indicate the directions of travel of the vehicles 100, 110 which are driving in opposite directions along the roadway 130. The first vehicle 100 may receive at least one Vehicle-to-X message from the second vehicle 110. The vehicle-to-X message 112 may include position information of the Target vehicle 110. The position information may be determined by utilization of a Global Navigation Satellite System supported by the second vehicle 110. Based only on this information hence without consideration of the actual course of the roadway 130 an intersection movement assist (IMA) application 226 of the Ego vehicle 100 may determine a potential safety threat if the direction and speed of travel of both vehicles 100, 110 would continue essentially unchanged.

In some implementations, a Roadside Unit (RSU) 300 is positioned in local proximity of the curve 132 of the roadway 130. The RSU 300 broadcasts an RSU signal/message 302 by wireless Vehicle-to-X communication. The RSU signal 302 may include information such as, but not limited to Roadside Alerts (RSA) and/or MAP-messages. The information may be indicative of the curved roadway 132.

The ego vehicle 100 includes an electronic control system 200 configured to reduce intersection false-positive detection of safety threats by the IMA 226 by outputting a warning signal 232 to the driver only when a safety threat by the IMA application 226 is determined based on the received vehicle-to-X message 112 and confirmed based on at least one other data 262, 272, 282, 302. The electronic control system 200 includes a wireless communication device 210, e.g., a Vehicle-to-X communication device. The wireless communication device 210 receives signals and messages by way of an antenna 212. The electronic control system 200 includes a vehicle controller 220 that includes a computing device (or processor) 222 (e.g., central processing unit having one or more computing processors) in communication with non-transitory memory 224 (e.g., a hard disk, flash memory, random-access memory) capable of storing instructions executable on the computing processor(s) 222. The controller 220 executes the IMA application 226 which receives the vehicle-to-X message 112 from the second vehicle 110 by way of the wireless communication device 210. The electronic control system 200 includes a signal interface 230. The signal interface 230 may be part of the processor 222 (not shown). Alternatively, the signal interface 230 may be in communication with the controller 220. Therefore, the IMA application 226 receives the vehicle-to-X message 112 and determines if a safety threat exists based on the vehicle-to-X message 112. If the IMA 226 determines that a safety threat does exist (i.e., the presence of an unsafe intersection), the IMA 226 confirms that the safety threat exists based on analyzing at least one other data 262, 272, 282, 302. For example, the IMA 226 may determine that the IMA 226 falsely identified a road curvature as an intersection, therefore, the IMA 226 does not transmit the warning message 232 to the user interface 240 and/or the autonomous vehicle controller 250 by way of the signal interface 230.

The electronic control system 200 is configured to receive, at the wireless communication device 310, roadside information 302 indicating a type of a traffic construction or road condition from the Roadside unit 300 and provide the roadside information 302 to the processor 222, and evaluate, by the processor 222, the type of road condition based on the received information 302. In addition, the electronic control system 200 outputs, by the signal interface 230, a signal 232 including the warning 232 to a driver of the vehicle via a user interface 240, e.g., by display 242 and/or audio 244 warning, or the signal 232 to an autonomous vehicle controller 250 causing a change in an autonomous interaction in the driving dynamics of the vehicle depending on the result of the evaluation i.e., based on the type of road condition.

The Ego vehicle 100 includes the wireless communication device 210 (e.g., a vehicle-to-X communication device 210) that receives the RSU signal or roadside information 302 from the RSU 300 and the Vehicle-to-X message 112 from the second vehicle 110. The processor 222 receives the roadside information 302 from the wireless communication device 210 and evaluates a type of a road condition based on the received roadside information 302. The intersection movement assist 226, executing on the processor 222, relies on the evaluated type of road condition and the information included in the Vehicle-to-X message 112 to determine that the Ego vehicle 100 is approaching a curve 132 and not a traffic intersection and therefore a safety threat is not given. Hence, no signal or warning to a driver of the Ego vehicle 100 respectively no (semi-) autonomous intervention to the Ego vehicle 100 dynamic to prevent a safety hazard is carried out. By additionally utilizing Roadside Unit information, a reduced number of false positives intersection detections can be achieved.

In some implementations, the electronic control system 200 includes a position determination device 260 that determines a vehicle position 262 of the vehicle 100. The position determination device 260 determines the vehicle position 262 based on a Global Navigation Satellite System, e.g., by GPS, GLONASS, GALILEO or BAIDU, supported by the first vehicle 100. By additionally utilizing the vehicle position 262, a reduced number of false positive intersection detections can be achieved.

In some examples, the electronic control system 200 includes a vehicle dynamics determination device 270 that determines vehicle dynamics data 272. The vehicle dynamics determination device 270 may include at least one acceleration sensor (not shown) in one or more directions and/or at least one gyroscopic sensor (not shown) in one or more planes. It is common that the direction of measurements of the individual acceleration sensors and/or gyroscopic sensors are orthogonal to each other. By additionally utilizing the vehicle dynamics data 272, a reduced number of false positive intersection detections can be achieved.

In some examples, the vehicle 100 includes a path prediction module 280. The path prediction module 280 is configured to plan and/or predict a trajectory or path 282 at least for predetermined period in future for the ego vehicle 100 to go. The path prediction may be based on information received from a route guidance system (not shown). By additionally utilizing the path predicted trajectory or path 282, a reduced number of false positive intersection detections can be achieved.

In some examples, the Vehicle-to-X message 112 includes at least one of a target vehicle position of the target vehicle 110 and a target vehicle dynamics information of a target vehicle. The controller 220 (i.e., the processor 222) may determine a first predicted route based on the vehicle position 262 and the vehicle dynamics data 272 of the first vehicle 100. In addition, the controller 220 (i.e., the processor 222) may also determine a second predicted route based on the received target vehicle position and the target vehicle dynamic. The controller 220 may determine a potential hazardous situation based on the first predicted route and the second predicted route. The potential hazardous situation may include, but is not limited to, a collision between the two vehicles 100, 110. The signal interface 230 outputs the signal 232 where the signal data includes the potential hazardous situation and the determined type of road condition. In this case, the user interface 240 warns the driver of the potential hazardous situation and the road condition, e.g., by way of the display 242 or the audio 244. Additionally or alternatively, the autonomous vehicle controller 250 adjusts the vehicle dynamics of the vehicle to avoid the potential hazardous situation. A potential hazardous situation may include a potential collision of the two vehicles or getting in close proximity, e.g. under a predetermined distance which may be dependent on the velocity of at least one of the vehicles 100, 110.

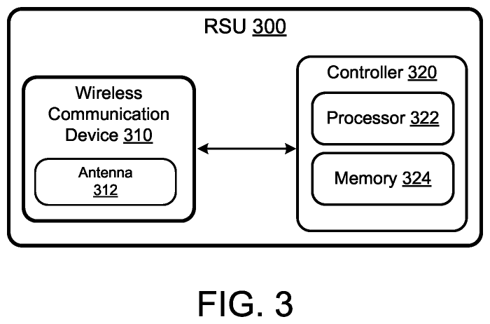

FIG. 3 shows a Roadside unit 300 that includes a wireless communication device 310 with an antenna 312, e.g., a Vehicle-to-X communication device. The Roadside unit 300 also includes a controller 320 having a processor 322 and a data memory 324. The Roadside Unit 300 is configured to read, by the processor 322, information indicating a type of road condition stored in the data memory 324, and send out, by the wireless communication device 310, information 302 indicating the type of road condition.

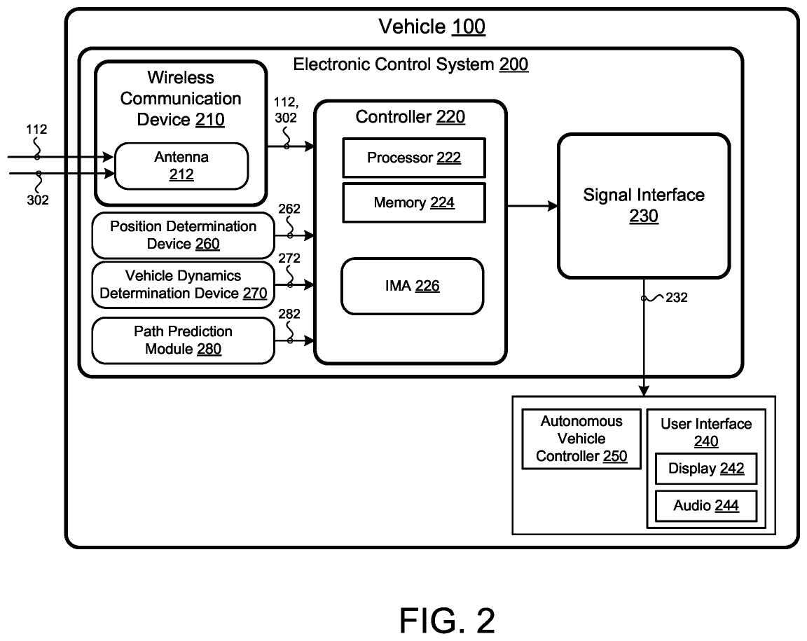

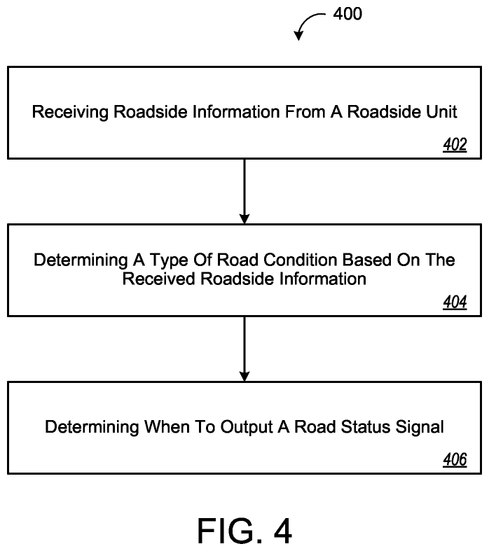

FIG. 4 provides an example arrangement of operations for a method 400 of reducing intersection false-positive detections based on the traffic situation shown in FIG. 1 and using the electronic control system 200 shown in FIG. 2 and the RSU 300 shown in FIG. 3. At block 402, the method 400 includes receiving, at data processing hardware, i.e., processor 222, roadside information 302 from a roadside unit 300. At block 404, the method 400 includes determining, at the data processing hardware 222, a type of road condition based on the received roadside information 302. At block 406, the method 400 includes determining when to output a road status signal 232 including the type of road condition to at least one of a vehicle user interface 240 or an autonomous vehicle controller 250 supported by the vehicle 100 based on the determined type of road condition. The road status signal 232 causing the user interface 240 to display a message on a vehicle display 242 or to output a sound on a vehicle audio 244 indicating the type of road condition. Additionally or alternatively, the road status signal 232 may cause the autonomous vehicle controller 250 to adjust a vehicle driving behavior based on the type of road condition.

In some examples, the method 400 includes receiving, at the processor 222, a vehicle-to-X message 112 from another vehicle 110. The method 400 also includes determining an existence of an intersection along the vehicle route based on the vehicle-to-X message 112. In other words, the processor 222 determines if the vehicle-to-X message 112 indicates that the other vehicle 110 is within an intersection. When the processor 222 determines that an intersection exists, then the processor 222 instructs the signal interface 230 to output a road status signal 232. When the processor 222 determines that the type of road condition is not an intersection, then the processor 222 does not instruct the signal interface 230 to output a road status signal 232. Therefore, the road status signal 232 is sent to the user interface 240 and/or the autonomous vehicle controller 250 when the received vehicle-to-X message 112 indicates that there is an intersection and when the RSU message 302 indicates that there is an intersection.

In some implementations, the roadside information 302 is received at a wireless communication device 210, e.g., vehicle-to-X communication device, supported by the vehicle 100 and in communication with the data processing hardware 222.

The method 400 may also include receiving, at the data processing hardware 222, a target vehicle position of a target vehicle 110 and a target vehicle dynamics information of the target vehicle. The method 400 includes determining, at the data processing hardware 222, a first predicted route based on a vehicle position 262 and vehicle dynamics information 272 of the vehicle 100. The vehicle position 262 is determines by a position determination device 260 supported by the vehicle 100. The vehicle dynamics information 272 are determined by a vehicle dynamics determination device 270. The method 400 also includes determining, at the data processing hardware 222, a second predicted route based on the received target vehicle position and the target vehicle dynamics information. Additionally, the method 400 includes determining, at the data processing hardware 222, a potential hazardous situation based on the first predicted route and the second predicted route. The method 400 also includes outputting the road status signal 232 including signal data. The signal data includes the potential hazardous situation and the determined type of road condition.

In some implementations, when the signal data of the road status signal 232 indicates that the road condition is not an intersection, the data processing hardware 222 does not output the road status signal 232. When signal data of the road status signal 232 indicates that the road condition is a curved roadway, the data processing hardware 222 does not output the road status signal 232.

The roadside information 302 may include at least one of Roadside Alert information or information describing a geometry of a roadway the vehicle is driving on. Additionally or alternatively, the roadside information 302 includes a MAP message or a SPaT message.

In some implementations, the method 400 includes providing at least part of the determined type of road condition to at least one of further driver assistance applications, such as, but not limited to, Electronic Emergency Brake Light (EEBL), Forward Collision Warning (FCW), Stationary Vehicle Warning (SVW), or Control Loss Warning (CLW) or autonomous driving applications (e.g., executing on the autonomous vehicle controller 250).

If in the course of the proceedings it transpires that a feature or a group of features is not absolutely necessary, then the applicant here and now seeks a wording of at least one independent claim, no longer comprising the feature or the group of features. This may, by way of example, involve a sub-combination of a claim existing as at the application date or a sub-combination of a claim existing as at the application date restricted by further features. Such claims or combinations of features, which are to be newly worded, are understood to also be covered by the disclosure of this application.

It is further pointed out that configurations, features and variants of aspects of the invention, which are described in the various embodiments or embodiment examples and/or shown in the figures, can be combined with one another as desired. Individual or multiple features are interchangeable as desired. Resulting combinations of features are understood to also be covered by the disclosure of this application.

Back references in dependent claims should not be construed as a waiver of the right to independent, objective protection for the features of the subclaims referred back to. These features can also be used in any combination with other features.

Features which are only disclosed in the description or features which are disclosed in the description or a claim only in conjunction with other features can, in principle, be of independent inventive relevance. They can therefore also be included separately in claims to distinguish from the prior art.

It should be pointed out in general that vehicle-to-X communication means, in particular, a direct communication between vehicles and/or between vehicles and infrastructure facilities and/or road users in general. By way of example, therefore, vehicle-to-vehicle communication or vehicle-to-infrastructure communication may be involved. Where communication between vehicles is referred to within the framework of this application, this can essentially, by way of example, take place within the framework of vehicle-to-vehicle communication, which typically takes place without the intermediary of a mobile network or a similar external infrastructure and which can therefore be distinguished from other solutions which, by way of example, are based on a mobile network. By way of example, vehicle-to-X communication can take place using the standards IEEE 802.11p or IEEE 1609.4. Vehicle-to-X communication can also be referred to as C2X communication. The sub-areas can be referred to as C2C (Car-to-Car) or C2I (Car-to-Infrastructure). The aspects of the invention expressly do not, however, exclude vehicle-to-X communication with the intermediary of, for example, a mobile network.

A number of implementations have been described. Nevertheless, it will be understood that various modifications may be made without departing from the spirit and scope of the disclosure. Accordingly, other implementations are within the scope of the following claims.

1. An electronic control system of a vehicle, the electronic control system comprising:
data processing hardware; and
memory hardware in communication with the data processing hardware, the memory hardware storing instructions that when executed on the data processing hardware cause the date processing hardware to perform operations comprising:
receiving roadside information from a roadside unit;
determining a type of road condition based on the received roadside information; and
determining when to output a road status signal including the type of road condition to at least one of a vehicle user interface or an autonomous vehicle controller supported by the vehicle based on the determined type of road condition, the road status signal causing the vehicle user interface to display a message to a driver or causing the autonomous vehicle controller to adjust a vehicle behavior based on the type of road condition.

2. The electronic control system according to claim 1, wherein the operations further comprise:
receiving a vehicle-to-X message from another vehicle;
determining an existence of an intersection along a vehicle route based on the vehicle-to-X message; and
when the type of road condition is an intersection, outputting the road status signal.

3. The electronic control system according to claim 2, wherein the operations further comprise:
when the type of road condition is not an intersection, not outputting the road status signal.

4. The electronic control system according to claim 1, wherein the roadside information is received at a wireless communication device supported by the vehicle and in communication with the data processing hardware.

5. The electronic control system according to claim 1, wherein the operations further comprise:
receiving a target vehicle position of a target vehicle and a target vehicle dynamics information of the target vehicle;
determining a first predicted route based on a vehicle position and vehicle dynamics information of the vehicle;
determining a second predicted route based on the received target vehicle position and the target vehicle dynamics information;
determining a potential hazardous situation based on the first predicted route and the second predicted route; and
outputting the road status signal including signal data, the signal data includes the potential hazardous situation and the determined type of road condition.

6. The electronic control system according to claim 5, further comprising:
a position determination device determining the vehicle position of the vehicle; and
a vehicle dynamics determination device determining the vehicle dynamics information of the vehicle.

7. The electronic control system according to claim 1, wherein when signal data of the road status signal indicates that the type of road condition is not an intersection, the data processing hardware does not output the road status signal.

8. The electronic control system according to claim 1, wherein when signal data of the road status signal indicates that the type of road condition is a curved roadway, the data processing hardware does not output the road status signal.

9. The electronic control system according to claim 1, wherein the roadside information includes at least one of Roadside Alert information or information describing a geometry of a roadway the vehicle is driving on.

10. The electronic control system according to claim 1, wherein the roadside information comprises a MAP message or a SPaT message.

11. The electronic control system according to claim 1, wherein the data processing hardware provides at least part of the determined type of road condition to at least one of further driver assistance applications or autonomous driving applications.

12. The electronic control system according to claim 1, wherein the data processing hardware outputs at least part of the determined type of road condition to a path prediction module of the vehicle.

13. The electronic control system according to claim 1, wherein the data processing hardware outputs at least part of the determined type of road condition to at least one of the following driver assistance applications:
Electronic Emergency Brake Light (EEBL),
Forward Collision Warning (FCW),
Stationary Vehicle Warning (SVW), or
Control Loss Warning (CLW).

14. A method of controlling an electronic control system of a vehicle, the method comprising:
receiving, at data processing hardware, roadside information from a roadside unit;
determining, by the data processing hardware, a type of road condition based on the received roadside information; and
determining, by the data processing hardware, when to output a road status signal to at least one of a vehicle user interface or an autonomous vehicle controller supported by the vehicle based on the determined type of road condition, the road status signal causing the vehicle user interface to display a message to a driver or causing the autonomous vehicle controller to adjust a vehicle behavior based on the type of road condition.

15. The method according to claim 14, further comprising:
receiving vehicle-to-X message from another vehicle;
determining an existence of an intersection along a vehicle route based on the vehicle-to-X message; and
when the type of road condition is an intersection, outputting the road status signal.

16. The method according to claim 15, further comprising when the type of road condition is not an intersection, not outputting a road status signal.

17. The method according to claim 14, further comprising:
receiving a target vehicle position of a target vehicle and a target vehicle dynamics information of the target vehicle;
determining a first predicted route based on a vehicle position and vehicle dynamics information of the vehicle;
determining a second predicted route based on the received target vehicle position and the target vehicle dynamics information;
determining a potential hazardous situation based on the first predicted route and the second predicted route; and
outputting the road status signal including signal data, the signal data includes the potential hazardous situation and the determined type of road condition.

18. An electronic control system of a vehicle, the electronic control system comprising:
data processing hardware; and
memory hardware in communication with the data processing hardware, the memory hardware storing instructions that when executed on the data processing hardware cause the date processing hardware to perform operations comprising:
receiving a vehicle-to-X communication;
determining a presence of an intersection along a road in front of the vehicle;
receiving data from one or more vehicle systems supported by the vehicle;
confirming the presence of the intersection based on the data; and
when the presence of the intersection is confirmed, sending a warning message to a vehicle user interface or an autonomous vehicle controller supported by the vehicle, the vehicle user interface displaying the warming message to a driver or the autonomous vehicle controller adjusting a vehicle behavior.

19. The electronic control system according to claim 18, wherein the one or more vehicle systems includes a wireless communication device configured to receive roadside information from a roadside unit positioned along the road, wherein the data includes the roadside information.

20. The electronic control system according to claim 18, wherein the one or more vehicle systems includes at least one of:
a position determination device configured to determine a vehicle position, wherein the data includes the vehicle position;
a vehicle dynamics device configured to determine vehicle dynamics data, wherein the data includes the vehicle dynamics data; or
a path prediction module configured to determine a predicted vehicle path, wherein the data includes the predicted vehicle path.

21. (canceled)
